(19) United States
(12) Patent Application Publication
(10) Pub. No.: US 2017/0099573 A1
(43) Pub. Date: Apr. 6, 2017

(54) COMMUNICATION APPARATUS, COMMUNICATION METHOD, AND COMPUTER-READABLE STORAGE MEDIUM

(71) Applicant: CANON KABUSHIKI KAISHA, Tokyo (JP)

(72) Inventor: Tetsuya Sawada, Kawasaki-shi (JP)

(21) Appl. No.: 15/279,299

(22) Filed: Sep. 28, 2016

(30) Foreign Application Priority Data
Oct. 1, 2015 (JP) 2015-196148

(51) Int. Cl. H04W 4/02

(52) U.S. Cl. CPC H04W 4/02; H04W 84/12

(57) ABSTRACT

A communication apparatus includes a first obtaining unit that obtains an access point's position information using wireless LAN communication, a second obtaining unit that obtains the communication apparatus' position using non-wireless LAN communication, a determination unit that determines whether a distance between the access point and the communication apparatus is less than or equal to a predetermined value, and a control unit configured to, in a case where the determination unit determines that the distance between the access point and the communication apparatus is less than or equal to the predetermined value, employ the access point's position information as the communication apparatus' position information and shift the second obtaining unit into a suspended state.

### BACKGROUND

Field

Aspects of the present invention generally relate to a communication apparatus, a communication method, and a computer-readable storage medium.

Description of the Related Art

In recent years, there have been increasing numbers of electronic apparatuses, such as digital cameras and printers, that are provided with a wireless local area network (LAN) station function. These electronic apparatuses are connected to a wireless LAN and used as a communication apparatus. Japanese Patent Application Laid-Open No. 2011-35768 discusses a technique for providing a wireless LAN function on a digital camera to make it easy to share images. The digital camera discussed in Japanese Patent Application Laid-Open No. 2011-35768 can be provided with a global positioning system (GPS) function. In a case where the digital camera discussed in Japanese Patent Application Laid-Open No. 2011-35768 is provided with the GPS function, the digital camera can obtain the digital camera's position information (its own position information) using the GPS function.

In the wireless LAN, a system for obtaining position information is proposed in Institute of Electrical and Electronics Engineers (IEEE) 802.11k standard and IEEE802.11v standard. For example, IEEE802.11k standard proposes a system for obtaining an access point's position information using local configuration information (LCI).

While there is a plurality of methods for obtaining a communication apparatus' position information as described above, unnecessary power can be consumed if a single communication apparatus concurrently executes the plurality of methods. In particular, a communication apparatus driven by a battery is required to suppress electric power consumption as much as possible, and it would be a problem if electric power consumption increases as a result of the plurality of methods for obtaining position information executed concurrently.

### SUMMARY OF THE INVENTION

Aspects of the present invention are generally directed to a technique for providing a communication apparatus that suppresses electric power consumption related to acquisition of position information and efficiently uses position information obtained through different methods.

According to an aspect of the present invention, a communication apparatus includes a first obtaining unit configured to obtain an access point's position information through communication via a wireless LAN, a second obtaining unit configured to obtain the communication apparatus' position information using a communication method different from the wireless LAN, a determination unit configured to determine whether a distance between the access point and the communication apparatus is less than or equal to a predetermined value, and a control unit configured to, in a case where the determination unit determines that the distance between the access point and the communication apparatus is less than or equal to the predetermined value, employ the access point's position information as the communication apparatus' position information and shift the second obtaining unit into a suspended state.

Further features of aspects of the present invention will become apparent from the following description of exemplary embodiments with reference to the attached drawings.

### BRIEF DESCRIPTION OF THE DRAWINGS

FIG. 1 is a diagram illustrating an example of a configuration of a communication system to which an exemplary embodiment of the present invention can be applied.

FIG. 2 illustrates a function block diagram of a communication apparatus according to a first exemplary embodiment.

FIG. 3 is a flowchart illustrating processing of a control unit according to the first exemplary embodiment.

FIG. 4 is a diagram illustrating a hardware configuration of the communication apparatus according to the first exemplary embodiment.

FIG. 5 is a diagram illustrating another example of a configuration of a communication system to which an exemplary embodiment of the present invention can be applied.

FIG. 6 is a function block diagram of a communication apparatus according to a second exemplary embodiment.

FIG. 7 is a flowchart illustrating processing of a control unit according to the second exemplary embodiment.

### DESCRIPTION OF THE EMBODIMENTS

Exemplary embodiments for carrying out the aspects of the present invention will be hereinafter described in details with reference to appending drawings. The exemplary embodiments described below are merely examples as means for realizing the aspects of the present invention, and the exemplary embodiments can be modified or changed as necessary according to the configurations and various conditions of apparatuses to which the aspects of the present invention are applied. Further, the aspects of the present invention are not limited to the following embodiments.

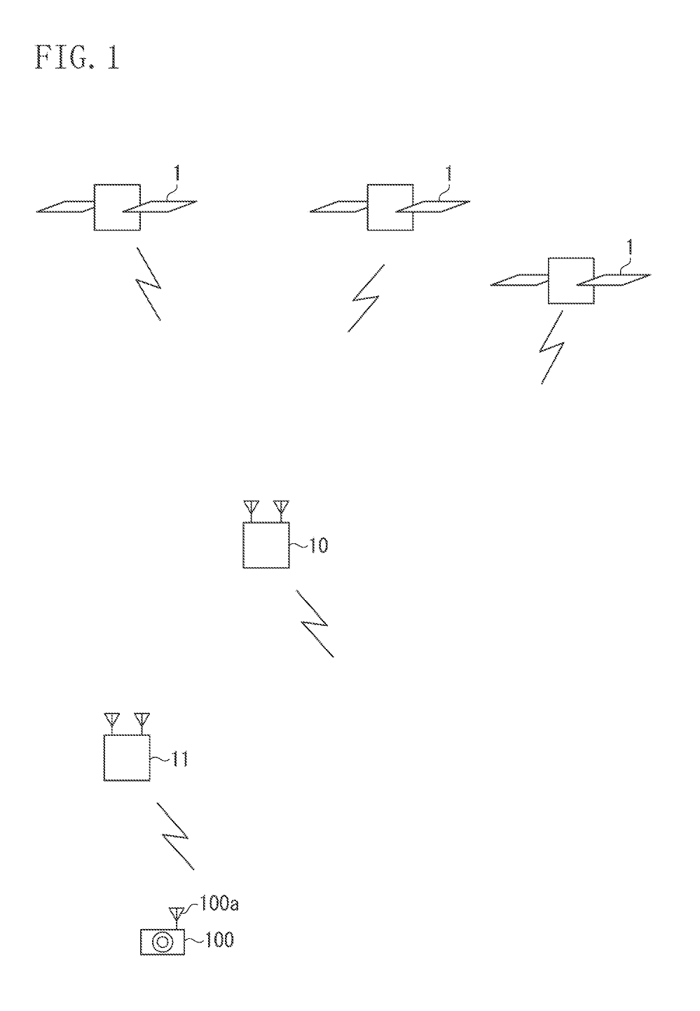

A first exemplary embodiment of the present invention will be hereinafter described with reference to FIGS. 1 to 4.

FIG. 1 illustrates an example of a communication system to which the present exemplary embodiment can be applied. This communication system includes a communication apparatus 100 according to the first exemplary embodiment of the present invention. More specifically, this communication system includes a plurality of global positioning system (GPS) satellites 1, two access points (hereinafter referred to as “AP”) 10 and 11, and the communication apparatus 100. The communication apparatus 100 is, for example, a digital camera. The communication apparatus 100 includes an antenna 100a used for performing wireless communication. Each of the GPS satellites 1 transmits time information and orbit information to the communication apparatus 100 using an electric wave. Each of the GPS satellites 1 includes an atomic clock, and transmits the electric wave carrying a signal including a highly accurate time to the earth. The GPS is one of a plurality of communication methods according to the present exemplary embodiment. FIG. 1 illustrates the three GPS satellites 1, but the number of the GPS satellites 1 is not limited to three.

The APs 10 and 11 are base stations operating in compliance with a standard of Institute of Electrical and Electronics Engineers (IEEE) 802.11 series. Each of the APs 10 and 11 provides its own position information to the communication apparatus 100 using the wireless local area network (LAN) in response to a request from the communication apparatus 100. Each of the APs 10 and 11 is regarded as a source of provision for position information. In the present exemplary embodiment, a distance from the AP to the communication apparatus 100 is assumed to be longer than a distance from the AP 11 to the communication apparatus 100. The APs 10 and 11 are assumed to be fixed at predetermined positions on the earth. The wireless LAN communication method in compliance with the standard of IEEE802.11 series is just one of a plurality of communication methods according to the present exemplary embodiment.

The communication apparatus 100 serving as a terminal apparatus of the APs 10 and 11 can communicate with the APs 10 and 11. Accordingly, from the perspective of the APs 10 and 11, the communication apparatus 100 is regarded as a station (hereinafter referred to as “STA”).

### (Acquisition of Position Information Using the GPS)

The communication apparatus 100 can receive time information and orbit information from each of the GPS satellites 1. Then, the communication apparatus 100 can derive (obtain) the position of the communication apparatus 100 based on the time information and the orbit information about the GPS satellites 1 transmitted from the plurality of GPS satellites 1. More specifically, the communication apparatus 100 can obtain its own position information based on the information received from the GPS satellites 1. Acquisition of the position information is described below.

First, the communication apparatus 100 measures an electric wave propagation time period for the time it takes for the electric wave to travel from a GPS satellite to the communication apparatus 100 based on the time information received from the GPS satellite 1. The communication apparatus 100 multiplies the electric wave propagation time period by the light speed to calculate the distance from the GPS satellite 1 to the communication apparatus 100. The communication apparatus 100 calculates the position of the GPS satellite 1 based on the orbit information about the GPS satellite 1 received from the GPS satellite 1. The communication apparatus 100 calculates the distances to three GPS satellites 1 and the positions of the three GPS satellites 1. If the distances to the three GPS satellites 1 and the positions of the three GPS satellites 1 are found, the position of the communication apparatus 100 can be obtained by solving a cubic equation. In a case where an error in calculation of the distances from the GPS satellites 1 to the communication apparatus 100 are taken into consideration, the position of the communication apparatus 100 can be obtained by using time information and orbit information transmitted from the fourth GPS satellite.

### (Acquisition of Position Information Using the Wireless LAN)

The communication apparatus 100 can obtain the communication apparatus' 100 position information using each AP's position information obtained from the APs 10 and in the proximity via the wireless LAN. When the communication apparatus 100 obtains its own position information, the communication apparatus 100 complies with, for example, the standard of IEEE802.11k. Acquisition of the position information is described below.

First, the communication apparatus 100 transmits a location configuration information (LCI) request signal to the APs 10 and 11. The APs 10 and 11, upon receipt of the LCI request signal, transmit the APs' 10 and 11 position information to the communication apparatus 100 in an LCI report format. The LCI includes information about the latitude, the longitude, and the altitude of the corresponding one of the APs. The communication apparatus 100, upon receipt of the LCI report, obtains its own position information using the latitude, the longitude, and the altitude of each of the APs 10 and 11 as the latitude, the longitude, and the altitude of the communication apparatus 100. A signal used by each of the APs 10 and 11 to transmit the LCI report to the communication apparatus 100 is referred to as an “LCI report signal” in the following description.

The communication apparatus 100, upon receipt of the LCI report, can obtain its own position information by estimating the position of the communication apparatus 100 based on the latitudes, the longitudes, and the altitudes of the APs 10 and 11 and the electric field strengths of the APs 10 and 11. In the following description, the communication apparatus 100, upon receipt of the LCI report, obtains its own position information by using the latitudes, the longitudes, and the altitudes of the APs 10 and 11 as the latitude, the longitude, and the altitude of the communication apparatus 100.

### (Function Block)

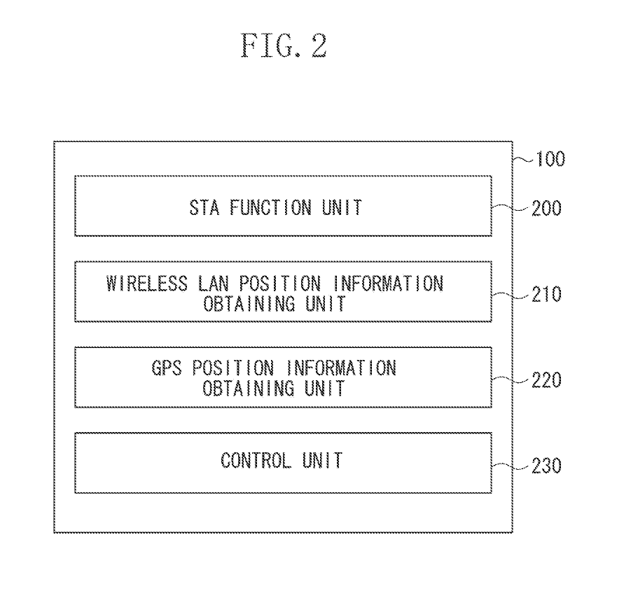

FIG. 2 is a function block diagram of the communication apparatus 100 according to the present exemplary embodiment.

The communication apparatus 100 includes an STA function unit 200, a wireless LAN position information obtaining unit 210, a GPS position information obtaining unit 220, and a control unit 230.

The STA function unit 200 performs control when the communication apparatus 100 operates as the STA of the wireless LAN. More specifically, the STA function unit 200 is compliant with IEEE802.11 series, and performs control when participating as the STA in the wireless network established by the APs 10 and 11.

The wireless LAN position information obtaining unit 210 receives the APs' 10 and 11 position information from the APs 10 and 11, respectively, via the wireless LAN. Then, the wireless LAN position information obtaining unit 210 uses the received position information as the communication apparatus' 100 position information.

The GPS position information obtaining unit 220 receives the GPS orbit information and the time information from each of the plurality of GPS satellites 1. The GPS position information obtaining unit 220 obtains (calculates) the position of the communication apparatus 100 based on the received orbit information and the received time information. In the present exemplary embodiment, the GPS position information obtaining unit 220 is assumed to be set in an OFF state in the initial settings.

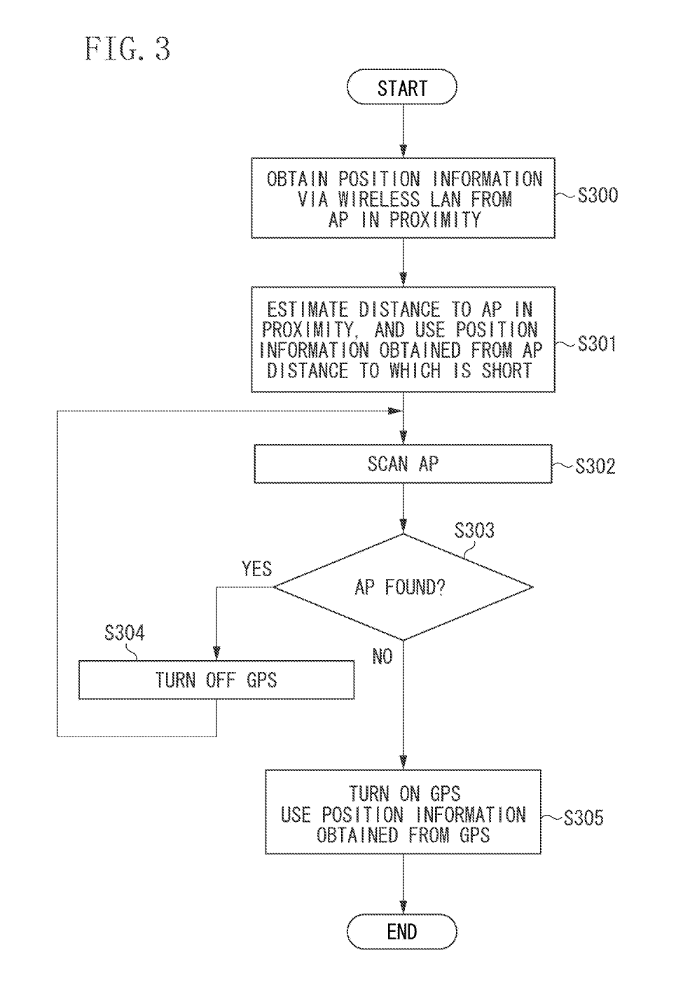

The control unit 230 controls the above-described operations of the STA function unit 200, the wireless LAN position information obtaining unit 210, and the GPS position information obtaining unit 220. The control unit 230 performs control to lower electric power consumption of the communication apparatus 100 and to efficiently use the obtained position information. For example, the control unit 230 controls the wireless LAN position information obtaining unit 210 and the GPS position information obtaining unit 220 to lower the electric power consumption of the communication apparatus 100. The control unit 230 efficiently uses the obtained position information by controlling the wireless LAN position information obtaining unit 210 and the GPS position information obtaining unit 220. The power consumption reduction and the efficient use of the obtained position information are described below with reference to FIG. 3.

Each function block illustrated in FIG. 2 is stored in a storage unit, such as a read only memory (ROM) 104 described below, as a program, and each function is executed by a central processing unit (CPU) 102. At least some of the function blocks as illustrated in FIG. 2 can be implemented with hardware. When hardware is used to implement a function block(s), for example, a predetermined compiler can be used to automatically generate a dedicated circuit on a field-programmable gate array (FPGA) from the program for implementing each step. A gate array circuit can be formed in a manner similar to the FPGA, and can be realized as hardware. Alternatively, it can be realized with an application specific integrated circuit (ASIC).

### (Power Consumption Reduction and Efficient Use of Position Information)

FIG. 3 is a flowchart illustrating processing executed by the communication apparatus 100 with regard to acquisition and use of position information. The flowchart of FIG. 3 is processed when the CPU 102 provided in the communication apparatus 100 executes the program stored in, for example, the ROM 104. The processing is, for example, executed while the communication via the wireless LAN is enabled. The processing is started in response to a start instruction provided by a user, and/or regularly started with a predetermined interval that is set in advance.

After the processing is started, in step S300, the wireless LAN position information obtaining unit 210 of the communication apparatus 100 transmits an LCI request signal to each of the APs 10 and 11 in proximity via the wireless LAN, and receives an LCI report signal from each of the APs 10 and 11 via the wireless LAN. Thereafter, the wireless LAN position information obtaining unit 210 obtains the communication apparatus' 100 position information based on the contents of the LCI report.

In step S301, the wireless LAN position information obtaining unit 210 estimates a distance from the communication apparatus 100 to the AP 10 (a source of provision for position information). More specifically, the wireless LAN position information obtaining unit 210 estimates the distance from the communication apparatus 100 to the AP 10 based on the strength of an LCI report signal (or a beacon signal) received from the AP 10. Similarly, the wireless LAN position information obtaining unit 210 estimates the distance from the communication apparatus 100 to the AP 11 based on the strength of the LCI report signal received from the AP 11.

The wireless LAN position information obtaining unit 210 compares the two estimated distances, and employs information about the latitude, the longitude, and the altitude of the AP 11 included in the LCI report received from the AP 11 the distance to which is shorter (in the example of FIG. 1, the AP 11 is closer to the communication apparatus 100 than the AP 10 is). More specifically, the wireless LAN position information obtaining unit 210 selects the AP 11, from between the two APs 10 and 11, which has a stronger electric wave of the wireless LAN, and obtains the communication apparatus' 100 position information using information about the latitude, the longitude, and the altitude included in the LCI report of the AP 11. As described above, in the present exemplary embodiment, in a case where a plurality of pieces of position information can be obtained via the wireless LAN, one of the plurality of pieces of position information is selected based on the distance from the communication apparatus 100 to each of the source of provisions (APs 10, 11) providing the corresponding one of the plurality of pieces of position information.

In step S302, the wireless LAN position information obtaining unit 210 transmits a probe request to the selected AP 11. In other words, the wireless LAN position information obtaining unit 210 scans the AP 11.

In step S303, the wireless LAN position information obtaining unit 210 determines whether a probe response has been received from the AP 11. More specifically, the wireless LAN position information obtaining unit 210 determines whether the AP 11 has been discovered in step S301.

Steps S302 and S303 are executed so that, for example, when the communication apparatus 100 moves, the value of the distance from the communication apparatus 100 to the AP 11 can become greater than or equal to a predetermined value. For example, when a certain period of time passes since the acquisition of each AP's position information, the distance to an AP located in close proximity to the communication apparatus 100 at the time of executing the processing in step S300 can become longer. In a case where the value of the distance from the communication apparatus 100 to the AP 11 is greater than or equal to the predetermined value, the communication apparatus' 100 position information should not be obtained using the position information received from the AP 11. This is because, in the present exemplary embodiment, the communication apparatus' 100 position information is obtained based on the fact that the distance to the AP 11 is short (the value of the distance is less than a predetermined value), so that, when the distance to the AP increases, the accuracy (the reliability) of the position information is reduced. Accordingly, the wireless LAN position information obtaining unit 210 transmits the probe request in step S303 to determine the reliability of the position information obtained via the wireless LAN.

The following is an example of the processing performed in steps S302 and S303. First, in step S300, the LCI request signal is transmitted with a higher transmission power so that the LCI request signal reaches a broader area. As a result, APs in a broader area can be found, and the position information is obtained from each AP. Then, a probe request to be transmitted in step S302 is transmitted with a lower transmission power so that it reaches a smaller area. As a result, it can be determined whether the AP selected in step S301 is located at a distance from the communication apparatus 100 that is greater than or equal to a predetermined distance, or located at a position less than or equal to the predetermined distance from the communication apparatus 100. The processing proceeds to step S304 in a case where a response to a probe request from an AP (YES in step S303) that reaches only a short distance. In other words, in a case where the distance to the AP selected in step S301 is less than or equal to the predetermined value, the processing proceeds to step S304. As described above, whether the distance from the communication apparatus 100 to the selected AP is short or long can be determined with the adjustment of the transmission powers of the LCI request signal to be transmitted in step S300 and the probe request to be transmitted in step S302.

In addition, the transmission power of the LCI request signal itself can be reduced in advance, and the position information can be obtained from an AP located at a distance from the communication apparatus 100 that is less than or equal to the predetermined value. In such a case, the transmission of the probe request can be omitted. More specifically, the processing in step S302 and step S303 can be omitted, and the processing can proceed to steps S304 and S305 according to whether the position information can be obtained in step S300.

In a case where the distance from the communication apparatus 100 to the AP 11 is greater than or equal to the predetermined value, the position information obtained from the GPS satellites 1 is considered to be more reliable than the position information obtained from the AP 11. Accordingly, in a case where the determination made in step S303 is “No” (described below), in the present exemplary embodiment, it is determined that the position information obtained from the wireless LAN communication is not to be employed, and the position information according to the GPS is obtained. In other words, the position information obtained using the GPS is determined to be employed as the communication apparatus' 100 position information. Accordingly, in a case where the determination made in step S303 is “NO”, the processing proceeds to step S305, and the power of the GPS position information obtaining unit 220 is turned ON.

As described above, the wireless LAN position information obtaining unit 210 determines, based on a predetermined condition that the reliability of the position information obtained from the AP 11 is not deteriorated (appropriate), that any one of two pieces of position information is employed as the communication apparatus' 100 position information.

In the flowchart of FIG. 3, turning ON the power of the GPS position information obtaining unit 220 is described as “turn ON GPS”.

In a case where the AP 11 can be found in step S303 (YES in step S303), the control unit 230 of the communication apparatus 100 causes the processing to proceed to step S304. In a case where the AP 11 cannot be found in step S303 (NO in step S303), the control unit 230 of the communication apparatus 100 causes the processing to proceed to step S305.

In step S304, the control unit 230 turns OFF the power of the GPS position information obtaining unit 220. Turning OFF the power means that, in a case where the power of the GPS position information obtaining unit 220 is in the OFF state when the processing in step S304 starts, the OFF state is maintained, and in a case where the power of the GPS position information obtaining unit 220 is in the ON state, the GPS position information obtaining unit 220 is turned OFF. In the present exemplary embodiment, the power of the GPS position information obtaining unit 220 is set to the OFF state in the initial settings, and accordingly, in step S304, this OFF state is maintained. In the flowchart of FIG. 3, turning OFF the power of the GPS position information obtaining unit 220 is described as “turn OFF GPS”.

Turning OFF the power of the GPS position information obtaining unit 220 also includes setting the function of the GPS position information obtaining unit 220 to a suspended state. More specifically, turning OFF the power of the GPS position information obtaining unit 220 includes shutting off the electric power supply and shifting the GPS position information obtaining unit 220 into sleep mode.

After the processing in step S304, the control unit 230 returns to the processing in step S302. After that, the determination result in step S303 is “Yes” and the power of the GPS position information obtaining unit 220 is maintained in the OFF state while the wireless LAN position information obtaining unit 210 keeps finding the AP 11.

In a case where the power of the GPS position information obtaining unit 220 is set to the ON state in the initial settings, the GPS position information obtaining unit 220 is turned OFF in step S304, and thereafter, the GPS position information obtaining unit 220 either consumes no electric power or consumes less electric power.

In step S305, the control unit 230 turns ON the power of the GPS position information obtaining unit 220. Turning ON the power means that, in a case where the power of the GPS position information obtaining unit 220 is in the ON state when the processing in step S305 starts, the ON state is maintained. In a case where the power of the GPS position information obtaining unit 220 is in the OFF state, the GPS position information obtaining unit 220 is turned ON.

Turning ON the power of the GPS position information obtaining unit 220 indicates shifting the function of the GPS position information obtaining unit 220 into the active state (cancelation of suspended state). More specifically, turning ON the power of the GPS position information obtaining unit 220 includes starting the electric power supply to the power of the GPS position information obtaining unit 220 and waking up the GPS position information obtaining unit 220 from the sleep mode by supplying power. After the control unit 230 turns ON the power of the GPS position information obtaining unit 220, the GPS position information obtaining unit 220 receives the orbit information and time information from the plurality of GPS satellites 1. The communication apparatus 100 obtains the position of the communication apparatus 100 using the received orbit information and time information, and terminates the processing.

As described above, according to the present exemplary embodiment, the communication apparatus 100 first obtains the communication apparatus' 100 position information by using the wireless LAN in steps S300 and S301. Then, when the AP 11 closest to the communication apparatus 100 can be found (YES in step S303), it is determined that the position information obtained via the wireless LAN has a sufficient level of reliability. Accordingly, acquisition of the position information with the GPS position information obtaining unit 220 is not obtained. In such a case, the communication apparatus 100 determines that the position information obtained through the communication method using the wireless LAN is to be employed, and the acquisition of the position information through the communication method using the global positioning satellite is not performed (suspended).

In other words, it is determined, based on a predetermined condition including the reliability of at least one of the position information obtained via the wireless LAN and the position information obtained using the GPS, that either one of pieces of position information obtained via the wireless LAN and using the GPS is employed as the communication apparatus' 100 position information.

In the present exemplary embodiment, the power of the GPS position information obtaining unit 220 is set to the OFF state in the initial settings, and as long as the determination result in step S303 is “Yes”, no or little electric power is consumed by the GPS position information obtaining unit 220). In the present exemplary embodiment, in a case where the communication apparatus 100 cannot find the AP 11 (NO in step S303), the acquisition of the position information is performed using the GPS position information obtaining unit 220. Accordingly, when the communication apparatus 100 obtains its own position information, the frequency of using the GPS position information obtaining unit 220 can be reduced. This configuration reduces (saves) the power consumption of the GPS position information obtaining unit 220, resulting in reduction of the electric power consumption in the entire communication apparatus 100. Consequently, in a case where the communication apparatus 100 uses the battery, the battery run-time can increase.

In the present exemplary embodiment, in a case where the predetermined condition is not satisfied (NO in step S303), it is determined that the position information obtained using the GPS is more reliable than the position information obtained via the wireless LAN, and the position information obtained using the GPS is employed as the position information about the communication apparatus 100. Accordingly, the position information obtained via the wireless LAN and the position information obtained using the GPS are efficiently used.

### (Hardware Configuration)

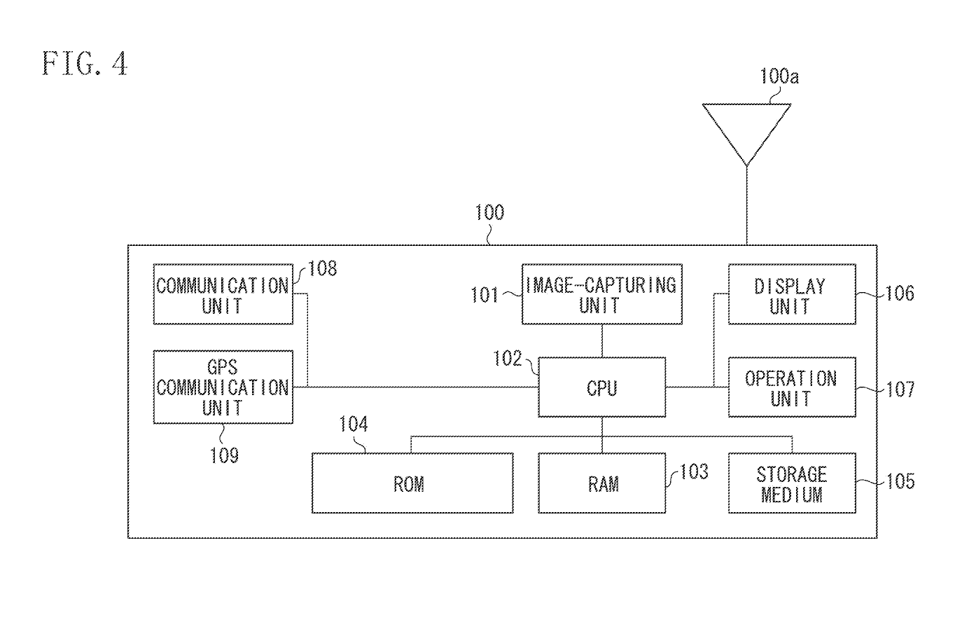

FIG. 4 illustrates an example of a hardware configuration of the communication apparatus 100. In the following description, the communication apparatus 100 is assumed to be a digital camera.

The digital camera serving as the communication apparatus 100 includes an image-capturing unit 101, the CPU 102, a random access memory (RAM) 103, the ROM 104, a storage medium 105, a display unit 106, an operation unit 107, a communication unit 108, a GPS communication unit 109, and the antenna 100a.

The image-capturing unit 101 includes an optical system (a lens, a shutter, and a diaphragm) and an image-capturing device. The optical system focuses light from a subject to form an optical image on the image-capturing device with an appropriate quantity of light and timing. The image-capturing device converts, into an image signal, the light that has passed through the optical system and has been formed into the optical image.

The CPU 102 controls various calculations and each portion constituting the digital camera according to input signals and programs. More specifically, the CPU 102 performs image-capturing control, display control, storage control, and communication control. The function blocks of FIG. 2 described above illustrate the functions executed by the CPU 102.

The RAM 103 temporarily stores data, and is used as a workspace of the CPU 102. The ROM 104 stores the programs for executing each function unit as illustrated in FIG. 2 and various setting information.

The storage medium 105 stores captured image data and a generated GPS log file. The storage medium 105, for example, is a memory card detachable from and attachable to the digital camera. When the storage medium 105 is mounted to a personal computer (PC), the stored captured image data can be read out. The digital camera has an access unit for accessing the storage medium 105, and can read and write data from and to the storage medium 105.

The display unit 106 displays a view finder image during image capturing, captured images, and characters for an interactive operation. The digital camera does not necessarily include the display unit 106.

The operation unit 107 is configured to receive a user's operation. The operation unit 107 includes, for example, a button, a lever, and a touch panel. The communication unit 108 wirelessly communicates with the APs 10 and 11 via the wireless LAN.

The GPS communication unit 109 obtains position information from the GPS satellites 1. The obtained position information is stored in the storage medium 105 as the GPS log file.

The control of the digital camera can be performed with a single hardware device or can be performed with a plurality of hardware devices functioning to execute the processing of the digital camera while the processing is shared by the plurality of hardware devices.

As discussed above, the digital camera is one example of the communication apparatus 100. The communication apparatus 100 can be a digital video camera, a smartphone, a tablet terminal, etc. The communication apparatus 100 does not need to include an image-capturing unit. In a case where the communication apparatus 100 does not include an image-capturing unit, the communication apparatus 100 can be, for example, a printer, a PC, a digital home electronic appliance, etc.

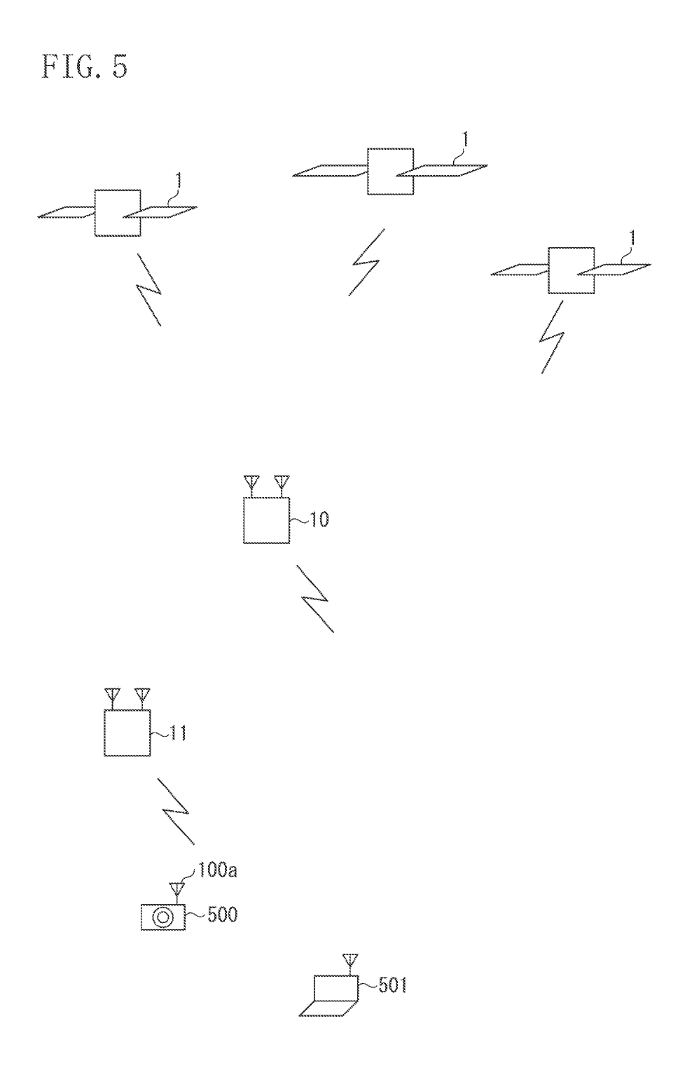

A second exemplary embodiment of the present invention is described below with reference to FIGS. 5 to 7.

According to the first exemplary embodiment, when the reliability of the position information obtained via the wireless LAN is appropriate (YES in step S303 of FIG. 3), the position information based on the GPS is not obtained. Aspects of the present invention are not limited thereto. According to the second exemplary embodiment, after position information is obtained via the wireless LAN, position information is obtained using the GPS, and these pieces of position information are compared to each other. In a case where it is determined that the reliability of the position information obtained via the wireless LAN is appropriate as a result of the comparison, the position information obtained via the wireless LAN is selected (employed) as the position information about the communication apparatus 100.

The communication apparatus according to the present exemplary embodiment can function as an STA and also function as an AP.

In the following description, the difference(s) from the first exemplary embodiment will be mainly described. The same elements as those of the first exemplary embodiment will be denoted by the same reference numerals, and detailed description thereof is omitted.

FIG. 5 illustrates a communication system according to the present exemplary embodiment, which includes a communication apparatus 500. More specifically, the communication system includes a plurality of GPS satellites 1, two APs 10 and 11, the communication apparatus 500, and a terminal apparatus 501. The communication apparatus 500 is an example of a wireless communication apparatus according to the present exemplary embodiment.

The communication apparatus 500 serves as a terminal apparatus of the APs 10 and 11, and communicates with the APs 10 and 11 via the wireless LAN. Accordingly, the communication apparatus 500 can be regarded as the STA from the perspective of the APs 10 and 11. The position information to be communicated between the communication apparatus 500 and each of the APs 10 and 11 is, for example, the LCI. The communication apparatus 500 can receive the time information and the orbit information from the GPS satellites 1. The communication apparatus 500 can receive position information about the APs 10 and 11 from the APs and 11 via the wireless LAN. The communication apparatus 500 includes an antenna 100a used when the wireless communication is performed.

The communication apparatus 500 itself, according to the present exemplary embodiment, serves as the AP, and can provide the communication apparatus' 500 position information to the terminal apparatus 501 therearound via the wireless LAN.

When the communication apparatus 500 functions as an AP, the terminal apparatus 501 receives the communication apparatus' 500 position information from the communication apparatus 500 via the wireless LAN. The terminal apparatus 501 obtains the terminal apparatus' 501 position information based on the communication apparatus' 500 position information. When the communication apparatus 500 functions as the AP, the terminal apparatus 501 can be regarded as the STA.

### (Function Block)

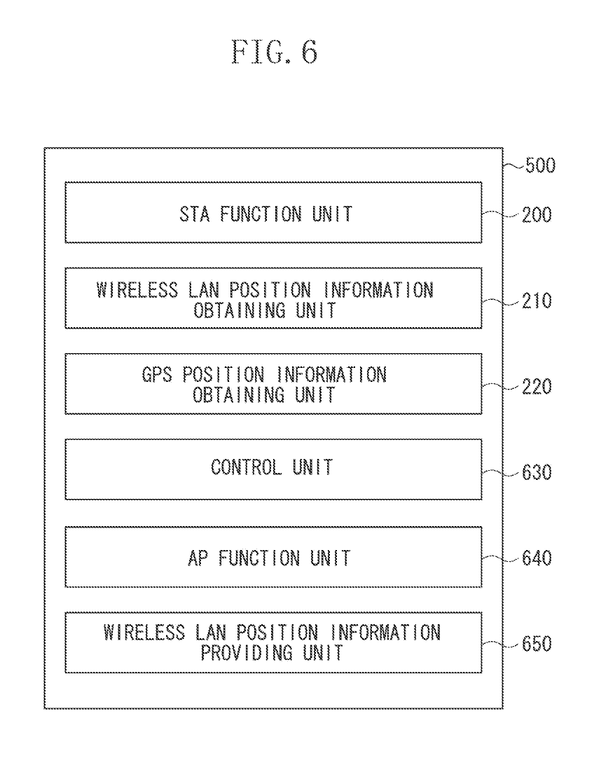

FIG. 6 is a function block diagram illustrating the communication apparatus 500 according to the present exemplary embodiment.

The communication apparatus 500 includes an STA function unit 200, a wireless LAN position information obtaining unit 210, a GPS position information obtaining unit 220, a control unit 630, an AP function unit 640, and a wireless LAN position information providing unit 650. The STA function unit 200, the wireless LAN position information obtaining unit 210, and the GPS position information obtaining unit 220 in FIG. 6 are similar to the STA function unit 200, the wireless LAN position information obtaining unit 210, and the GPS position information obtaining unit 220 according to the first exemplary embodiment in FIG. 2, respectively.

The STA function unit 200 performs control when the communication apparatus 500 operates as the STA of the wireless LAN. The wireless LAN position information obtaining unit 210 receives the APs' 10 and 11 position information from the APs 10 and 11 via the wireless LAN, and obtains the communication apparatus' 500 position information. The GPS position information obtaining unit 220 receives the GPS orbit information and the time information from the plurality of GPS satellites 1, and obtains the communication apparatus' 500 position information. In the present exemplary embodiment, the GPS position information obtaining unit 220 is assumed to be set in the OFF state in the initial setting.

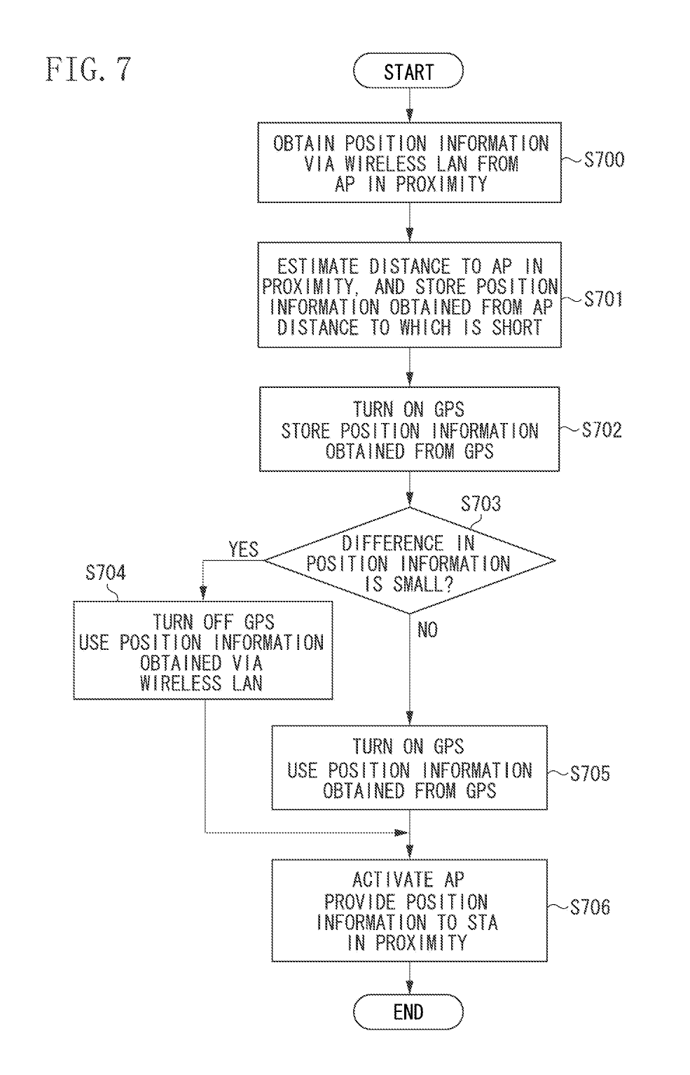

The control unit 630 controls the above-described operations of the STA function unit 200, the wireless LAN position information obtaining unit 210, the GPS position information obtaining unit 220, the AP function unit 640, and the wireless LAN position information providing unit 650. The control unit 630 performs control to lower the electric power consumption of the communication apparatus 500 and efficiently use the obtained position information. For example, the control unit 630 controls the wireless LAN position information obtaining unit 210 and the GPS position information obtaining unit 220 to lower the electric power consumption of the communication apparatus 500. The control unit 630 controls the wireless LAN position information obtaining unit 210 and the GPS position information obtaining unit 220 to efficiently use the obtained position information. The power consumption reduction and the efficient use of the obtained position information are described with reference to FIG. 7.

The AP function unit 640 performs control when the communication apparatus 500 operates as an AP of the wireless LAN. More specifically, the AP function unit 640 is compliant with IEEE802.11 series, and performs control when the communication apparatus 500 serves as an AP to establish a wireless network. The terminal apparatus 501 participates as an STA in the wireless network.

The wireless LAN position information providing unit 650 provides the communication apparatus' 500 position information to the terminal apparatus 501 via the wireless LAN in response to a request from the terminal apparatus 501.

Each function block illustrated in FIG. 6 is stored in a storage unit, such as the ROM 104, as a program, and each function is executed by the CPU 102. At least some of the function blocks illustrated in FIG. 6 can be implemented with hardware. When hardware is used to implement the function blocks, for example, a predetermined compiler can be used to automatically generate a dedicated circuit on the FPGA from the program for implementing each step. A gate array circuit can be formed in a manner similar to the FPGA, and can be realized as hardware. Alternatively, it can be realized with the ASIC.

The hardware configuration of the communication apparatus 500 according to the present exemplary embodiment is similar to the hardware configuration (FIG. 4) of the communication apparatus 100 according to the first exemplary embodiment, and the description thereof is omitted.

### (Power Consumption Reduction and Efficient Use of Position Information)

FIG. 7 is a flowchart illustrating processing executed by the communication apparatus 500 with regard to acquisition and use of position information. Each step in the flow chart illustrated in FIG. 7 is processed when the CPU 102 provided in the communication apparatus 500 executes the program stored in, for example, the ROM 104. The processing is, for example, executed while the communication via the wireless LAN is enabled. The processing is started in response to a start instruction provided by a user, and/or regularly started with a predetermined interval that is set in advance.

Step S700 is executed after the processing is started. The process of step S700 is similar to step S300 according to the first exemplary embodiment, and the description thereof is omitted.

In step S701, the wireless LAN position information obtaining unit 210 estimates the distance from the communication apparatus 500 to the AP 10 and the distance from the communication apparatus 500 to the AP 11 through a similar method as the first exemplary embodiment. The wireless LAN position information obtaining unit 210 compares the two estimated distances, and selects, based on information about the latitude, the longitude, and the altitude of the AP 11 the distance to which is shorter from the communication apparatus 500, a piece of position information from among pieces of the obtained communication apparatus' 500 position information. The selected position information is temporarily stored in the RAM 103 (FIG. 4).

In step S702, the control unit 630 turns ON the power of the GPS position information obtaining unit 220. After the power of the GPS position information obtaining unit 220 is turned ON, the GPS position information obtaining unit 220 receives the orbit information and the time information from the plurality of GPS satellites 1. The communication apparatus 500 derives (obtains) information about the latitude, the longitude, and the altitude of the communication apparatus 500, based on the received orbit and time information, and temporarily stores these pieces of information to the RAM 103 as the position information.

In step S703, the position information stored in step S701 and the position information stored in step S702 are compared to each other, and when the difference between the two pieces of position information is less than or equal to a predetermined difference, the difference is determined to be small. Otherwise, the difference is determined to be large. In the present exemplary embodiment, as an example of a comparison method, when each of the differences of the latitudes and the longitudes included in the two pieces of position information is within a predetermined range, the difference is determined to be small.

In a case where the difference is determined to be small, the control unit 630 causes the processing to proceed to step S704. Otherwise, the control unit 630 causes the processing to proceed to step S705.

In step S704, the control unit 630 turns OFF the power of the GPS position information obtaining unit 220. Then, the control unit 630 determines that the position information (the position information obtained via the wireless LAN) temporarily stored in step S701 is to be employed as the communication apparatus' 500 position information. More specifically, at the point of step S703, the communication apparatus 500 has the two pieces of position information (the position information obtained in step S701 and the position information obtained in step S702) as the communication apparatus' 100 position information, but in a predetermined case, the control unit 630 determines that the position information obtained in step S701 is to be employed.

The predetermined case is a case where the difference between the two pieces of position information is small. In a case where the difference between the two pieces of position information is small, the two pieces of position information are both considered to be correct. More specifically, the reliability of each of the two pieces of position information can be regarded as appropriate. In such a case, it is sufficient to use the position information obtained via the wireless LAN to lower the electric power consumption of the communication apparatus 500 (to lower the electric power consumption in the GPS position information obtaining unit 220). Accordingly, in step S704, the power of the GPS position information obtaining unit 220 is turned OFF.

In a case where the determination in step S703 is “Yes”, it is determined that the position information obtained via the wireless LAN is to be employed as the communication apparatus' 500 position information. Then, the position information obtained using the GPS becomes unnecessary. Accordingly, in step S704, the power of the GPS position information obtaining unit 220 is turned OFF. After step S704, the control unit 630 causes the processing to proceed to step S706.

In other words, in step S703, the reliability of each of the position information obtained via the wireless LAN and the position information obtained using the GPS, and the electric power consumption related to the acquisition of the communication apparatus' 500 position information are taken into consideration. In view of the above, in step S703, it is determined whether the position information obtained via the wireless LAN or the position information obtained using the GPS is employed as the communication apparatus' 500 position information.

In step S705, while the power of the GPS position information obtaining unit 220 is kept in the ON state, the control unit 630 determines that the position information (position information obtained using the GPS) temporarily stored in step S702 is to be employed as the communication apparatus' 500 position information. More specifically, at the point of step S703, the communication apparatus 500 has the position information obtained in step S701 and the position information obtained in step S702 as the communication apparatus' 100 position information, but the control unit 630 determines to use the position information obtained in step S702 based on a result of determination in step S703. In this case, it has been determined in step S703 that there is a large difference between the position information obtained in step S701 and the position information obtained in step S702. In a case where the difference between two pieces of position information is large, both the position information obtained via the wireless LAN (the position information obtained in step S701) and the position information obtained using the GPS (the position information obtained in step S702) are considered to be inappropriate position information. In the present exemplary embodiment, in such a case, between the two, the position information obtained using the GPS is considered to be appropriate, and the position information obtained using the GPS is employed. After step S705, the control unit 630 causes the processing to proceed to step S706.

In step S706, in a case where the control unit 630 receives an LCI request signal from the terminal apparatus 501 via the wireless LAN, the control unit 630 activates the AP function unit 640 and the wireless LAN position information providing unit 650. With this activation, the control unit 630 causes the communication apparatus 500 to operate as an AP. When the communication apparatus 500 receives the LCI request signal from the terminal apparatus 501 via the wireless LAN, the communication apparatus 500 transmits the LCI report signal to the terminal apparatus 501 via the wireless LAN. With the transmission of the LCI report signal, the communication apparatus 500 provides the communication apparatus' 500 position information determined (set) in step S704 or step S705 to the terminal apparatus 501.

As described above, according to the present exemplary embodiment, the communication apparatus 500 first obtains the communication apparatus' 100 position information via the wireless LAN in steps S700 and S701, and also obtains the communication apparatus' 100 position information using the GPS in step S702. Then, in step S703, the communication apparatus 500 determines whether the reliability of each of the two pieces of position information is appropriate. Thereafter, in steps S704 and S705, the communication apparatus 500 determines which of the pieces of position information is to be employed based on the predetermined condition (the reliability of the position information and the electric power consumption of the communication apparatus). In the present exemplary embodiment, when the reliability of the position information obtained via the wireless LAN and the reliability of the position information obtained using the GPS are both appropriate, the position information obtained via the wireless LAN is used in view of the electric power consumption. In a case where the reliability of the position information obtained via the wireless LAN is considered to be lower than the reliability of the position information obtained using the GPS (NO in step S703), the communication apparatus 500 uses the position information obtained using the GPS in view of the reliability (accuracy) of the position information. As described above, in the present exemplary embodiment, the pieces of position information obtained through two communication methods are efficiently used.

In the present exemplary embodiment, in a case where the determination in step S703 is “Yes”, the position information obtained via the wireless LAN is used. Accordingly, the position information obtained using the GPS becomes unnecessary, and then the power of the GPS position information obtaining unit 220 is turned OFF (the GPS communication unit 109 is suspended). The power of the GPS position information obtaining unit 220 is turned ON in step S702, but when the determination in step S703 is “Yes”, no electric power is to be consumed by the GPS position information obtaining unit 220 (or the electric power consumption is very small) after step S704. Therefore, the electric power consumed by the GPS position information obtaining unit 220 can be reduced (electric power saving).

### (Modification)

The first and second exemplary embodiments are simply examples, and the aspects of the present invention are not limited to the first and second exemplary embodiments.

For example, in the above description, the acquisition of the position information based on the GPS and the acquisition of the position information via the wireless LAN have been described. The aspects of the present invention can also be applied to a case where position information is obtained according to another communication method. For example, Global Navigation Satellite System (GNSS) such as GLONASS, Galileo, and Compass can be used instead of the GPS in an environment enabling the use of such a system. The position information obtained from quasi-zenith satellites can be used instead of or together with the GPS satellite. The aforementioned GPS, GLONASS, and Compass are examples of a communication method using a global positioning satellite.

In the first exemplary embodiment, in step S301, the communication apparatus 100 selects, from the APs 10 and 11, the AP 11 that is closer in distance, based on the strength of the LCI report signal, but the method for selecting either one of the APs 10 and 11 is not limited thereto. For example, the communication apparatus 100 can select an AP that has transmitted an LCI report including the finest granularity (the degree of fineness) of the position information, and use position information provided from the AP. The granularity of the position information means the minimum unit (e.g., a unit of a meter and a unit of several tens of centimeters) of the position information. The granularity of the position information in a unit of several tens of centimeters is finer than that of the position information in a unit of a meter. Alternatively, a predetermined AP list is prepared, and an AP can be selected through a method or a rule different from the method described in the first exemplary embodiment.

According to the first exemplary embodiment, the presence of the AP 11 selected in step S301 can be confirmed by a probe response in step S302 and step S303, and whether the processing proceeds to step S304 or step S305 is determined according to a result of the confirmation. However, the aspects of the present invention are not limited to such a method. For example, when it can be confirmed that the communication apparatus 100 does not move after step S301, whether to proceed to step S304 or step S305 can be determined depending on whether it can be confirmed.

In steps S302 to 303 according to the first exemplary embodiment, the communication apparatus 100 can confirm the presence of the AP 11 based on whether a beacon has been received instead of a probe response.

In the second exemplary embodiment, in step S703, the position information obtained by using the GPS and the position information obtained by using the wireless LAN are compared to each other, and either one of the pieces of position information is employed. In another case, the two pieces of position information cannot be compared to each other in step S703. In such a case, either one of the pieces of position information, for example, the position information obtained using the GPS, can be employed.

In step S703 according to the second exemplary embodiment, a determination can be based on a format of each of the two pieces of position information instead of making a determination based on the difference between two pieces of position information (the position information obtained using the GPS and the position information obtained via the wireless LAN). More specifically, in a case where the format of the position information obtained using the GPS is different from the format of the position information obtained via the wireless LAN, the control unit 630 of the communication apparatus 500 causes the processing to proceed to step S705, and can determine that the position information obtained using the GPS is to be employed.

In the second exemplary embodiment, the position information using the GPS and the position information via the wireless LAN are compared to each other in step S703, and in a case where the difference therebetween is small, the processing proceeds to step S704, and the GPS is turned OFF. However, the aspects of the present invention are not limited thereto. For example, the position information obtained from the AP 10 and the position information obtained from the AP 11 can be compared to each other, and in a case where the difference therebetween is small, the processing proceeds to step S704, and the GPS can be turned OFF.

Each of the communication systems in FIGS. 1 and 5 includes two APs, but the number of APs included in the communication system is not limited to two.

### Other Embodiments

Aspects of the present invention can also be realized with processing for providing a program for realizing one or more functions according to the above embodiments to a system or an apparatus via a network or a storage medium, and causing one or more processors of a computer of the system or the apparatus to read and execute the program. Aspects of the present invention can also be realized with a circuit (for example, an application-specific integrated circuit (ASIC)) realizing one or more functions.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-196148, filed Oct. 1, 2015, which is hereby incorporated by reference herein in its entirety.

What is claimed is:

1. A communication apparatus comprising:
a first obtaining unit configured to obtain an access point's position information through communication via a wireless LAN;
a second obtaining unit configured to obtain the communication apparatus' position information using a communication method different from the wireless LAN;
a determination unit configured to determine whether a distance between the access point and the communication apparatus is less than or equal to a predetermined value; and
a control unit configured to, in a case where the determination unit determines that the distance between the access point and the communication apparatus is less than or equal to the predetermined value, employ the access point's position information as the communication apparatus' position information and shift the second obtaining unit into a suspended state.

2. The communication apparatus according to claim 1, wherein, in a case where the first obtaining unit obtains a plurality of access points' position information, the control unit selects a piece of position information, based on a distance between each of the plurality of access points and the communication apparatus, and determines that the selected position information is employed as the communication apparatus' position information.

3. The communication apparatus according to claim 1, wherein the determination unit transmits a probe request to the access point whose position information has been obtained so that the determination unit determines whether the distance between the access point and the communication apparatus is less than or equal to the predetermined value.

4. The communication apparatus according to claim 1, wherein the communication method used by the second obtaining unit is a communication method using a global positioning satellite.

5. The communication apparatus according to claim 1, wherein the first obtaining unit obtains the access point's position information using local configuration information (LCI) based on IEEE802.11k standard.

6. A communication method comprising:
obtaining an access point's position information through communication via a wireless LAN;
obtaining a communication apparatus' position information using a communication method different from the wireless LAN;
determining whether a distance between the access point and the communication apparatus is less than or equal to a predetermined value;
employing, in a case where it is determined that the distance between the access point and the communication apparatus is less than or equal to the predetermined value, the access points' position information as the communication apparatus' position information; and
suspending obtaining the communication apparatus' position information.

7. A computer-readable storage medium storing computer executable instructions for causing a computer to execute a method, the method comprising:
obtaining an access point's position information through communication via a wireless LAN;
obtaining a communication apparatus' position information using a communication method different from the wireless LAN;
determining whether a distance between the access point and the communication apparatus is less than or equal to a predetermined value;
employing, in a case where it is determined that the distance between the access point and the communication apparatus is less than or equal to the predetermined value, the access points' position information as the communication apparatus' position information; and
suspending obtaining the communication apparatus' position information.
